(19) United States
(12) Patent Application Publication
(10) Pub. No.: US 2006/0186182 A1
(43) Pub. Date: Aug. 24, 2006

(54) Cream solder printing metal mask with positioning function and its positioning method

(75) Inventor: Kiyoaki Koyama, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/354,070

(22) Filed: Feb. 15, 2006

(30) Foreign Application Priority Data
Feb. 22, 2005 (JP) 2005-045116

(51) Int. Cl. B23K 31/02; B23K 35/12; B05C 17/08

(52) U.S. Cl. 228/215; 228/245; 101/127; 118/504

(57) ABSTRACT

Rectangular positioning lands are formed on a circuit board, and rectangular positioning openings are formed in a metal mask. In addition, the positioning lands and positioning openings are formed such that their long side length becomes identical, and short side of the positioning opening becomes narrower than that of the positioning land. This enables to modify the deviation angle θ between the circuit board and the metal mask, and positional deviation in X and Y directions of the circuit board, during performing test printing, by modifying the position of the metal mask with respect to the circuit board, such that exposed excess parts, on which cream solder is not formed, are formed on the positioning lands, and the excess parts formed upper and lower sides of the cream solder mutually keep a constant spacing to become a same width.

The present application is based on and claims priority of Japanese patent application No. 2005-045116 filed on Feb. 22, 2005, the entire contents of which are hereby incorporated by reference.

### BACKGROUND OF THE INVENTION

1. Field of the Invention

The present invention relates to a cream solder printing metal mask, by which cream solder is printed from openings formed therein to land patterns of a circuit board by a squeegee sliding on the surface of the metal mask, especially, relates to a cream solder printing metal mask which is configured such that the land patterns and the openings are aligned, when the cream solder is printed, and its positioning method.

2. Description of the Related Art

Conventionally, when a surface mounting electronic part is mounted on a circuit board, soldering is performed by printing cream solder on a land (conductive pattern) on the circuit board, positioning electrodes such as lead terminals of the electronic part on the cream solder, and reflowing it.

The above cream solder printing involves attaching a metal mask to a printing machine; superposing the metal mask with circuit boards transferred along a manufacturing line, and printing cream solder on a land pattern of the circuit board from openings formed in the metal mask by a squeegee sliding on the metal mask. However, when the circuit board to be soldered is altered, a layout such as the conductive pattern of the circuit board is altered, consequently, the printing shape of cream solder changes significantly, thereby, it is also required to replace the metal mask to be attached to the printing machine by corresponding one.

During attaching the metal mask to the printing machine, it is required to precisely align openings formed in the metal mask and land patterns formed on the circuit board, and as such a prior art for aligning the circuit board and the metal mask, various kinds of literatures have been disclosed in the past.

For example, in Japanese Patent Laid-Open Publication No. H9-76454 (patent document 1), a method for performing alignment, based on forming plurality of identifying marks corresponding to a circuit board and a metal mask, photographing them by a photographing device such as a camera, detecting the coordinates of the identifying marks using an image identifying device, storing the coordination data of the respective identifying marks, correcting the relative position between the circuit board and the metal mask depending on the deviation amount between both data, and further directly identifying the deviation amount between the narrower pitch lands on the circuit board and the corresponding openings of the metal mask, is disclosed. In this method, first, the circuit board is photographed, in order to identify the identifying marks formed on the circuit board, and an image is taken. Next, the image is read by the identifying device, and the coordinate data of the identifying marks taken in the image is stored. After then, in order to identify the identifying marks on the circuit board and the corresponding identifying marks of the metal mask, by photographing the metal mask, reading the image with the identifying device, obtaining the coordination data of the identifying marks taken in the image, and comparing the both positional data, deviation amount between both of them is detected. The method is configured so as to perform alignment by correcting the relative position between the metal mask and the board using the deviation amount.

In addition, in Japanese Patent Laid-Open Publication No. 2000-233488 (patent document 2), a method for aligning a board in screen printing is disclosed, in which, by providing plurality of feature points to the circuit board and the metal mask, which are mutually apart from, and reading the coordination data of the feature points through the photographing device or the like, the deviation angle between the circuit board and the metal mask is found from the coordinates of respective feature points to correct the position of the circuit board.

Further, in Japanese Patent Laid-Open Publication No. H11-126962 (patent document 3), a cream solder printing mask for aligning a metal mask with respect to a circuit board by providing positioning guide members on a diagonal line of the circumference of a metal mask, boring positioning guide holes in the board, and fitting the guide members into the guide holes, is disclosed.

However, in the cases of patent documents 1 and 2, photographing device or identifying device for reading positioning lands or features points are required, and moreover application software or the like for correcting the position of a circuit board based on the data from the photographing device or identifying device is required, resulting in complexity of total device and increase of manufacturing cost.

In the case of patent document 3, every time when a metal mask is set to a circuit board, it is required to align a guide member and an positioning hole by fitting them, resulting in inefficient productivity. Thus, as mentioned above, as for the alignment of a metal mask with respect to a circuit board, if the metal mask is initially set to the board precisely, it is not required to align every time when the metal mask is set to the circuit board, thereby, as for the positioning structure for fitting the guide member and the positioning hole every time when the circuit board is superposed to the metal mask, as patent document 3, the productivity becomes rather inefficient.

### SUMMARY OF THE INVENTION

The present invention is performed in view of the above mentioned problem, and intended to provide a cream solder printing metal mask with positioning function which enables to align the metal mask with respect to the circuit board precisely, in simple and low cost configuration, without using special exclusive parts or the like, and its positioning method.

The cream solder printing metal mask with positioning function according to a first aspect, is a cream solder printing metal mask including openings formed corresponding to land patterns formed on a circuit board, when cream solder is printed from the openings on the land patterns by a squeegee sliding on the surface of the opening, configured so as to align the land patterns and openings wherein, on the circuit board, positioning lands are formed at positions located on non-used areas of the land patterns, and in the metal mask, positioning openings are formed corresponding to the positioning lands, the positioning lands and the positioning openings are formed in a rectangular shapes, and the short side width of the positioning openings is formed narrower than that of the positioning lands.

According to the configuration of the first aspect, the positioning lands and the positioning openings of the metal mask corresponding to the positioning lands are formed in rectangular shapes, respectively, and the length of the short side of the positioning opening is formed to be narrower than that of the positioning lands, thereby, even if one of the short sides is aligned and deviation is occurred, the deviation of the other short side becomes larger than that of the aligned short side, enabling identification of the deviation by viewing. This enables to visually align the positioning lands and the positioning openings such that their long sides become in parallel. In addition, the positioning lands and the positioning openings have same configurations, only in difference of purposes of usage, as those of the lands and openings for attaching electronic parts, respectively, thereby, special construction or members and forming means are not required.

The cream solder printing metal mask with positioning function described in the first aspect according to a second aspect, includes the positioning lands and the positioning openings positioned on corners of the circuit board and the metal mask, respectively, and provided on diagonal lines.

According to the configuration of the second aspect, a small deviation occurred when one of positioning lands and positioning openings are aligned, appears at the other positioning land and positioning opening spaced apart from the positioning land and the positioning opening as a large deviation, easily enabling the identification of the deviation by viewing, by forming one pair of the positioning land and the positioning opening at respective corners, and further forming another pair of them on respective diagonal lines.

The method for positioning a metal mask according to a third or fourth aspect includes a method wherein, when using the cream solder printing metal mask described in the first or second aspect, cream solder is printed on a land pattern of the land of a circuit board, excess parts exposing a positioning land along its long side are formed via cream solder, by superposing the circuit board and the metal mask, and sliding a squeegee on the upper surface of the metal mask to perform test printing of the cream solder on the positioning land from the positioning opening the metal mask is aligned by positioning the cream solder on the center of the positioning land such that the excess parts become in a constant spacing.

According to the configuration of the third or fourth aspect, the alignment of the metal mask by viewing can be easily performed, because excess parts exposing the positioning land are formed on the positioning land along its long side by contacting the circuit board and the metal mask and sliding a squeegee on the upper surface of the metal mask to perform test printing of the cream solder from the positioning openings on the positioning lands via printed cream solder, and the alignment of the metal mask is performed by positioning the cream solder to the center of the positioning land such that the excess parts have a constant width at every point.

### BRIEF DESCRIPTION OF THE DRAWINGS

FIG. 1 is a perspective view of a circuit board and a metal mask showing an embodiment 1 of the present invention;

FIG. 2 is a partially enlarged plane view showing a state in which the deviation angle θ between the circuit board and the metal mask of the present invention;

FIG. 3 is a partially enlarged plane view showing a state in which cream solder is printed with the deviation angle θ between the circuit board and the metal mask of the present invention;

FIG. 4 shows a process in which the cream solder along the plane A-A of FIG. 2 is printed, and (a) is a sectional view showing a state before printing; (b) is a sectional view showing a state after printing; and (c) is a sectional view showing a state after printing with the metal mask being lifted up;

FIG. 5 is a plane view showing the printing state of the positioning solder, and (a) is a view showing a state just after the positioning solder is printed; (b) is a view showing a state in which X direction is corrected from the state (a); and (c) is a view showing a state in which Y direction is corrected from the state (b); and

FIG. 6 is a plane view showing an modified example in which a plurality of circuit boards are used, and (a) shows a situation in which three circuit boards are used; and (b) shows a situation in which two circuit boards are used.

### DETAILED DESCRIPTION OF THE PREFERRED EMBODIMENTS

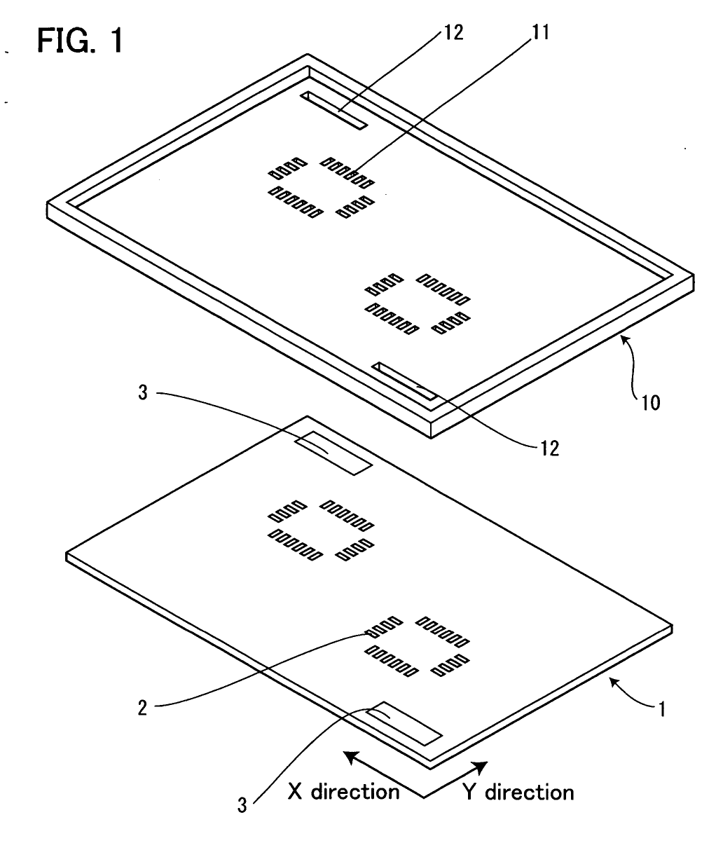

Now, referring to FIG. 1 to FIG. 6, an embodiment as the best mode for carrying out the present invention will be described below. It is appreciated that it is not necessary to describe that the present invention can be also applied easily to a subject which is not described in the embodiment, within a scope which does not depart from the object of the invention.

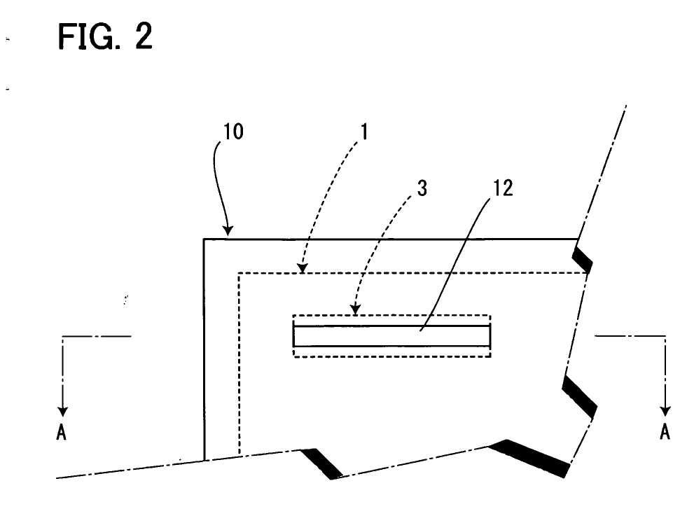

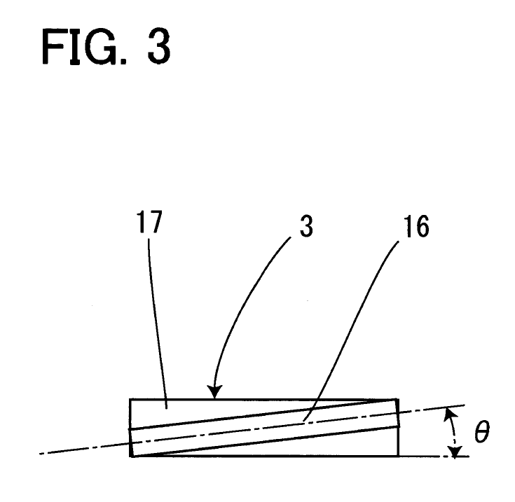

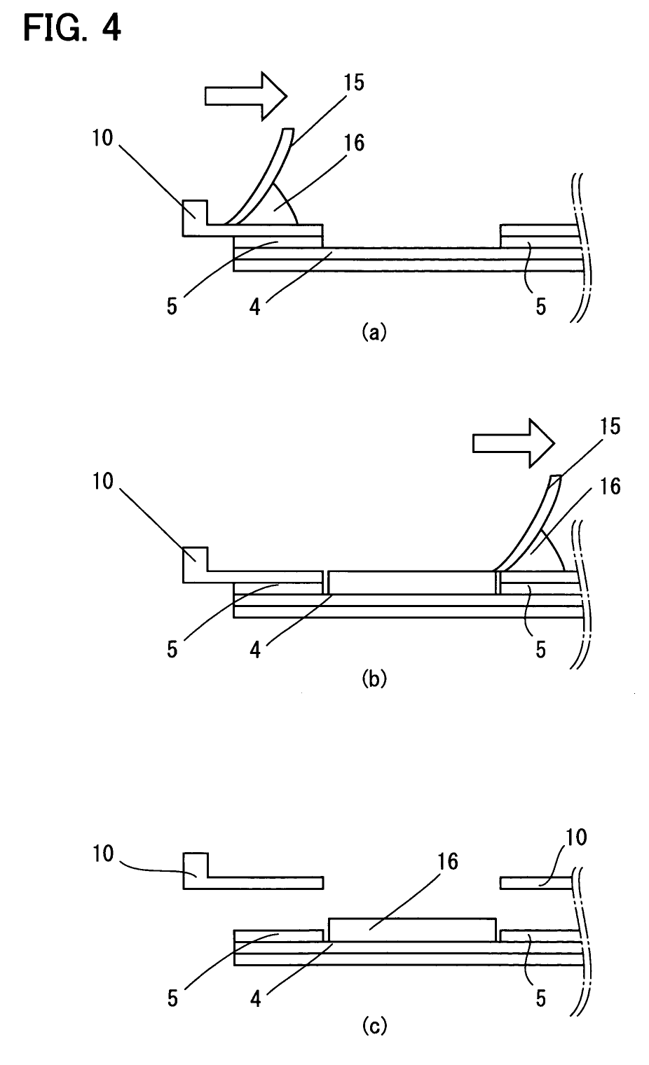

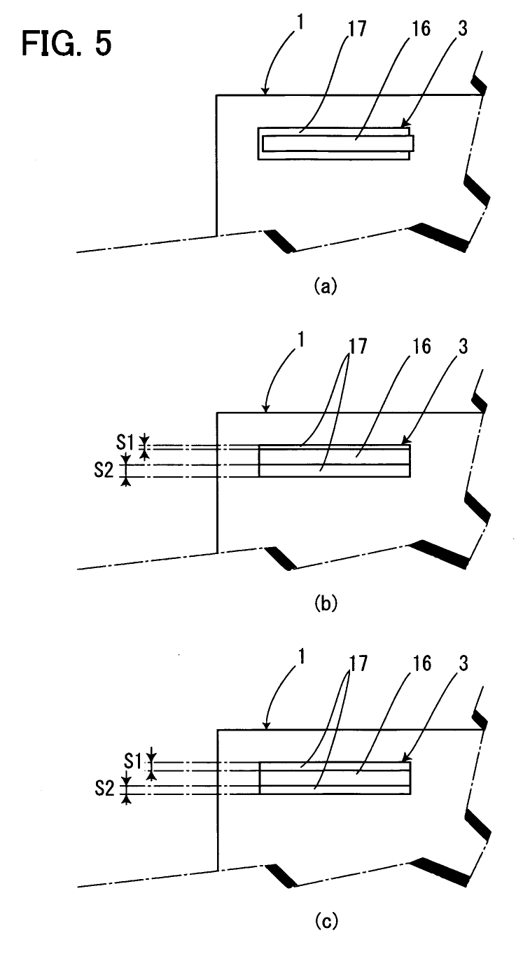

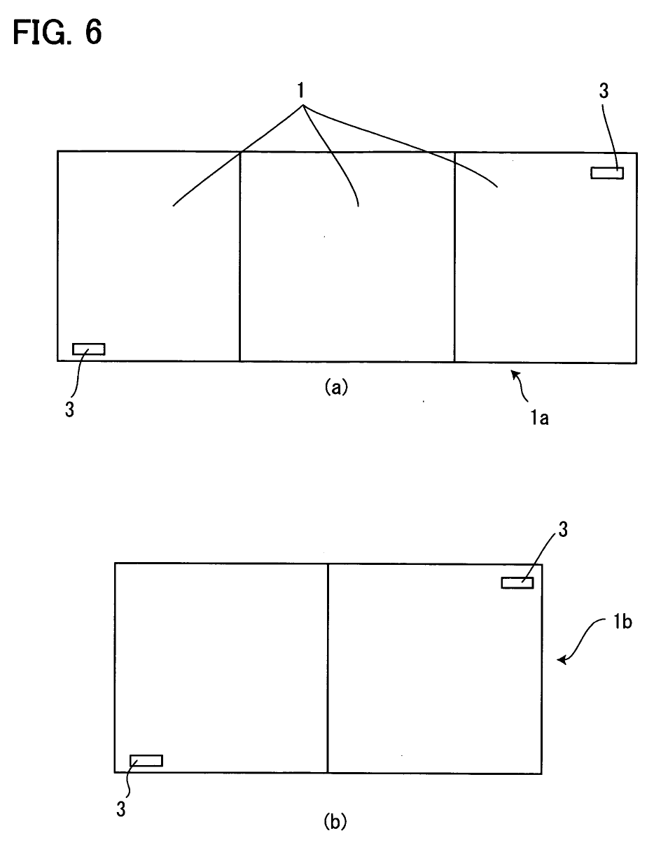

FIG. 1 to 6, show an embodiment of the present invention; FIG. 1 is a perspective view showing a circuit board on which cream solder of an embodiment 1 is printed, and a metal mask; FIG. 2 is a view showing a situation in which the circuit board and the metal mask are contacted each other, and the deviation angle is corrected; and FIG. 3 is a view showing a situation in which the cream solder is printed with the positioning lands and the positioning openings being deviated by an angle θ. FIG. 4 is a sectional view along the plane A-A of FIG. 2, and showing a process in which the cream solder is printed; (a) is a view showing a situation before printing; (b) is a view showing a situation after printing; and (c) is a view showing a situation after printing with the metal mask being separated. FIG. 5 is a view showing a process in which the metal mask is aligned in X and Y directions; (a) is a view showing a situation before aligning; (b) is a view showing the alignment in X direction; and (c) is a view showing the alignment in Y direction. FIG. 6 is a view showing an example in which a complex circuit board is used; (a) is a view showing an example in which three circuit boards are used; and (b) is a view showing an example in which two circuit boards are used.

As shown in FIG. 1, the surface of a circuit board 1 formed in a rectangular shape with longer side, is provided with a land 2 for soldering terminals of an electronic part (not shown) to be mounted on the circuit board 1, and positioning lands 3. The land 2 and the positioning lands 3 are intended to be formed by printing and forming a resist layer 5 on a pattern 4 formed on the circuit board 1 with a conductive material such as a copper foil except for the parts of the land 2 and the positioning lands 3. This makes only the land 2 and the positioning lands 3 be exposed, and the others be insulated by the resist layer 5. The positioning lands 3 are intended to be used for aligning with a metal mask mentioned below, thereby, they are not mounted with an electronic part, however, have substantially identical configurations to that of the land 2. The positioning lands 3 are provided to a circuit board 1 on at least two parts, in this example, they are located on the corners of the circuit board 1, and formed on a diagonal line.

The metal mask 10 is formed with a rectangular metal thin board made of stainless steel or nickel, for example, and openings 11 are formed in the metal mask at part corresponding to the part, the land 2, of the circuit board 1 on which cream solder is intended to be printed. In addition, positioning openings 12 are formed on the corners of the metal mask 10 correspondingly to the positioning lands 3 of the circuit board 1, and, in the preparative stage of the printing step, alignment of the circuit board 1 and the metal mask 10 is performed by matching the locations of the positioning openings 12 and the positioning lands 3. In addition, both of the positioning lands 3 and the positioning openings 12 formed on the circuit board land in the metal mask 10, respectively, have elongated rectangular shapes extending along the long side direction (X direction in FIG. 1) of the circuit board 1. In addition, the long side lengths of the positioning lands 3 and the positioning openings 12 are identical, however, in the short side direction (Y direction in FIG. 1), length of the positioning openings 12 is formed shorter than that of the positioning lands 3, especially, the long side lengths of the positioning lands 3 and the positioning openings 12 are 4 mm, and in the short side direction, the length of the positioning lands 3 (Land) is 0.5 mm, and the length of the positioning openings 12 is 0.22 mm.

In this embodiment configured as above, a method for aligning with a circuit board 1 using a metal mask 10 will be described below. First, an alignment of the metal mask 10 attached to a printing device is performed with respect to the circuit board 1 which is automatically transferred by the printing device and fixed at a predetermined location. Namely, correction of the deviations of the metal mask 10 in X and Y directions is performed, however, if the metal mask 10 is inclined by an angle θ with respect to the circuit board 1 at that time, the corrections of the metal mask 10 in X and Y directions cannot be performed, thereby, first, the inclination of the metal mask 10 is corrected. In this method, test printing is performed prior to the printing step of the metal mask 10. Thus, as shown in FIG. 4, cream solder 16 is printed from the opening 11 and the positioning openings 12 on the land 2 and the positioning lands 3 by sliding a squeegee 15 on the surface of the metal mask 10. Here, since the positioning openings 12 are formed narrower than the positioning lands 3 in the short side direction (Y direction), the cream solder 16 and excess parts 17 exposing the positioning lands 3 would be formed on the positioning lands 3 because of the difference of mutual widths of the positioning lands 3 and positioning openings 12. As shown in FIG. 3, if the cream solder 16 formed on the excess parts of the positioning lands 3 is inclined by an angle θ by identifying by viewing, the excess parts 17 does not become a constant spacing, thereby the parallelism of the metal mask 10 with respect to the circuit board 1, that is, if the metal mask 10 is inclined or not, can be identified simply and easily. In this manner, if the cream solder 16 formed on the excess parts 17 of the positioning lands 3 is identified to correct the angle of the metal mask 10 such that the excess parts 17 become a constant spacing, the parallelism of the metal mask 10 with respect to the circuit board 1 is suitable.

Next, deviation of the metal mask 10 in X direction will be corrected. Since the long side of the positioning openings 12 is made equal to that of the positioning lands 3, by this correction, the long side of the cream solder 16 is printed to be equal to that of the positioning lands 3. This allows to correct the deviation of the metal mask 10 in X direction, as shown in FIG. 5(B), by repeating X directional adjustment of the metal mask 10 in FIG. 5(A) such that the cream solder 16 falls into place without protruding from the positioning land 3.

In addition, in order to correct the deviation in Y direction of the metal mask 10, as shown in FIG. 5(C), adjustment of the metal mask 10 in Y direction of FIG. 5(B) is repeated such that the widths S1 and S2 of the excess parts 17 formed upper and lower sides of the cream solder 16 become an equal spacing. Thus, in this example, since the positioning lands 3 are rectangles of which long side is made to 4.0 mm, and short side is made to 0.5 mm, on the other hand, the positioning openings 12 are rectangles of which long side is made to 4.0 mm, and short side is made to 0.22 mm, the cream solder 16 which has an equivalent size (long side: 4.0 mm, short side: 0.22 mm) to that of the positioning openings 12, would be printed on the positioning lands 3, thereby, adjustment in X direction may be performed such that a pair of short sides of the cream solder 16 superposes to a pair of short sides of the positioning lands, respectively, and further adjustment in Y direction may be performed such that S1 and S2 of the excess parts 17 both become to 0.14 mm. In this manner, the alignment of the metal mask 10 can be performed precisely.

As mentioned above, according to the embodiment 1 of the present invention, by forming the positioning lands 3 on the circuit board 1, and the positioning openings 12 in the metal mask 10, in parallel to the traversing direction of the circuit board 1, the angle alignment of the deviation angle θ by viewing can be easily performed, and by adjusting such that the short sides of the respective pairs of the cream solder 16 and the positioning lands 3 are superposed, alignment in X direction can be performed, and further by comparing the widths S1 and S2 of the excess parts 17 of the positioning lands 3 on which the cream solder 16 is printed, alignment in Y direction can also be performed. By using this method, it is possible to precisely perform the alignment of the metal mask 10 by viewing, without using expensive identifying marks, photographing device, or identifying device. Especially, since the positioning lands 3 and the positioning openings 12 are rectangles, respectively, when identifying the excess parts 17 by viewing, it is possible to identify if the excess parts 17 are parallel or not in a simple and easy way, resulting in effective alignment of the metal mask 10. Further, since the short side of the positioning openings 12 for the cream solder 16 being printed are formed shorter than those of the openings 11 formed in the metal mask 10 for the other electronic parts being attached, higher printing precision is required more than that of the cream solder for attaching the other electronic parts. If the width size of the openings 11 is narrow, when, as shown in FIG. 4(A) and 4(B), the cream solder 16 is printed by sliding a squeegee, the cream solder 16 hardly enters from the openings, and when, as shown in FIG. 4(B) to 4(C), the metal mask 10 is lifted up, the snap-off property of the cream solder 16 deteriorates, thereby, the possibility that the cream solder 16 is lifted up with being attached to the metal mask 10 is also high, resulting in the tendency that sufficient amount of cream solder 16 hardly attaches to the land 2. Therefore, by making the width of the positioning openings 12 narrower than that of the openings 11 such that soldering becomes harder, and identifying the state such as the coating build-up of the cream paste 16 printed on the positioning lands 3, whole of the printing precision of the circuit board 1 can be understood roughly.

In addition, since forming the positioning lands 3 on the circuit board 1, and positioning openings 12 in the metal mask 12 are performed in steps similar to that of forming the lands 2 and the openings 11 for mounting other electronic parts, special steps for the positioning lands 3 and the positioning openings 12 are not required, enabling to form the positioning lands 3 and the positioning openings 12 inexpensively.

In addition, by providing the positioning lands 3 and the positioning openings 12 locating on respective corners on a diagonal line to identify the cream solder 16 and the excess parts 17 formed on the positioning lands 3 respectively, even if a deviation angle θ, which is so small that it cannot be identified by viewing the cream solder 16 and the excess parts 17 formed on any one of the positioning lands 3, occurs, it appears as large deviation by identifying the cream solder 16 and the excess parts 17 on the other positioning land 3 locating on the diagonal line. Therefore, it is possible to identify the deviation of the metal mask 10 by viewing, more correctly and surely.

As above, one embodiment of the present invention has been described in detail, however, the present invention is not limited to the above mentioned embodiment, rather various types of variations within the scope of the present invention can be performed. For example, in the above embodiment, an example in which the positioning lands 3 located on a diagonal line of one circuit board 1 are formed, is shown, however, as shown in FIG. 6(A) and (B), in complex type circuit boards 1a and 1b in which three or two circuit boards are combined, the positioning lands 3 may be formed so as to locate on the corners of the circuit board 1 arranged at both sides. In addition, it is not always necessary to form a pair of positioning lands 3 on the diagonal line of the circuit board 1, rather it is possible to perform the alignment of the metal mask 10 with respect to the circuit board 1 by only one positioning land 3.

The effects of the present invention are as follows.

The positioning openings and the positioning lands formed as rectangles in the cream solder printing metal mask with positioning function and on the circuit board according to the first aspect, respectively, and the long sides of the respective rectangles are arranged in parallel to the long sides of the metal mask and the board, respectively. In addition, the length of the short side of the positioning openings is formed shorter than that of the positioning lands. The fact that positioning openings and the positioning lands are made as rectangles, enables to suitably correct the deviation angle between the metal mask and the circuit board by viewing by aligning the both long sides to be in parallel.

Since in the cream solder printing metal mask with positioning function described in the first aspect, the positioning lands and the positioning openings are positioned at the corners of the circuit board and the metal mask, respectively, and provided on diagonal lines, in the cream solder printing metal mask with positioning function according to the second aspect, if, for example, alignment is performed using short sides of the positioning land and the positioning opening, even when the deviation between the positioning land and the positioning opening is very small such that it cannot be judged by viewing, more larger deviation than the deviation appears at the other positioning land and positioning opening arranged diagonally. This enables to perform the visual correction of deviation angle more precisely than the case when the positioning land and the positioning opening are single, respectively.

The positioning method of the metal mask according to the third aspect, using the metal mask and the test board described in the first or second aspect, test printing of cream solder is performed from the positioning openings on the positioning lands, by contacting the openings of the metal mask and the lands of the circuit board, and sliding a squeegee on the metal mask, resulting in printing of the cream solder on the positioning lands along their long sides. In addition, according to the positioning openings described in the first aspect, the short sides of the openings are formed shorter than those of the positioning lands, thereby, cream solder having narrower width than the positioning lands printed by the positioning openings, is printed on the positioning lands, forming excess parts via the cream solder. The alignment of the metal mask is performed such that the widths of the excess parts become a constant width at every position. By performing this procedure repeatedly, it is possible to perform the alignment between short sides of the positioning openings and the positioning lands precisely by viewing.

What is claimed is:

1. A cream solder printing metal mask with positioning function including openings formed corresponding to land patterns formed on a circuit board, and when cream solder is printed from the openings on the land patterns by a squeegee sliding on the surfaces of the openings, configured so as to align the land patterns and the openings, wherein, on the circuit board, positioning lands are formed at positions located on non-used areas of the land patterns, and, in the metal mask, positioning openings are formed corresponding to the positioning lands, the positioning lands and the positioning openings are formed in rectangular shapes, and the short side width of the positioning openings is formed narrower than that of the positioning lands.

2. The cream solder printing metal mask with positioning function according to claim 1, wherein the positioning lands and the positioning openings are positioned on corners of the circuit board and the metal mask, respectively, and provided on diagonal lines.

3. A method for positioning a metal mask, wherein, when using the cream solder printing metal mask according to claim 1, cream solder is printed on a land pattern of a land of a circuit board, excess parts exposing a positioning land along its long side are formed via cream solder, by superposing the circuit board and the metal mask, and sliding a squeegee on the upper surface of the metal mask to perform test printing of the cream solder on the positioning land from the positioning opening, and the metal mask is aligned by positioning the cream solder on the center of the positioning land such that the excess parts become in a constant spacing.

4. The method for positioning the metal mask, wherein, when using the cream solder printing metal mask according claim 2, cream solder is printed on the land pattern of the land of the circuit board, excess parts exposing the positioning land along its long side are formed via cream solder, by superposing the circuit board and the metal mask, and sliding the squeegee on the upper surface of the metal mask to perform test printing of the cream solder on the positioning land from the positioning opening, and the metal mask is aligned by positioning the cream solder on the center of the positioning land such that the excess parts become in a constant spacing.
